(19) United States
(12) Patent Application Publication
(10) Pub. No.: US 2015/0032328 A1
(43) Pub. Date: Jan. 29, 2015

(54) RECONFIGURABLE PERSONALIZED VEHICLE DISPLAYS

(71) Applicants: Jennifer Healey, San Jose, CA (US); Alexandra Zafiroglu, Portland, OR (US)

(72) Inventors: Jennifer Healey, San Jose, CA (US); Alexandra Zafiroglu, Portland, OR (US)

(21) Appl. No.: 13/977,556

(22) PCT Filed: Dec. 29, 2011
(86) PCT No.: PCT/US2011/067819

§ 371 Date: Sep. 20, 2013

(51) Int. Cl. G09F 21/04

(52) U.S. Cl. CPC G09F 21/04; B60W 2040/0881
USPC 701/36

(57) ABSTRACT

Certain embodiments of the invention may include systems, methods, and apparatus for reconfigurable personalized vehicle displays. According to an example embodiment of the invention, a method is provided for executing computer-executable instructions by one or more processors for displaying personalized information on a vehicle. The method can include detecting an identity of at least one of the one or more processors, display information based at least in part on the detected occupant identity; configuring the display information for use by one or more display devices associated with the vehicle; and communicating the configured display information to the one or more display devices.

### FIELD OF THE INVENTION

This invention generally relates to externally viewable vehicle displays, and in particular, to reconfigurable personalized vehicle displays.

### BACKGROUND OF THE INVENTION

As people move through the world, their vehicles can be used as a form of expression. People can express themselves via their vehicles in a number of ways, including bumper stickers, vanity license plates, signs, etc. The make, model, and color of the vehicle can even be considered an expression of the owner's preferences or status. Bumper stickers, for example, can advertise, amuse, entertain, or even provoke a response. Political party preferences and social causes can be displayed on a vehicle for all to see. Parents can let those around them know that a baby is in the vehicle, or that their child is doing well in school. Music bands often produce bumper stickers in hopes that their fans will attach one to their vehicles for free advertising.

Situations exist where it may be inappropriate, or even disallowed, to express certain ideas via an vehicle. Some companies discourage or forbid political or religious slogans on vehicles that park on company property. Situations also exist where family members need to share vehicles. For example, a parent may need to share a vehicle with a teenager, but may feel uncomfortable being seen in a vehicle adorned with messages appropriate for the teenager's peers, and vice versa. It is not convenient to selectively expose, cover, or remove bumper stickers, vanity plates, or other forms of expression based on the driver of the vehicle or the location of the vehicle.

### BRIEF DESCRIPTION OF THE FIGURES

Reference will now be made to the accompanying figures and diagrams, which are not necessarily drawn to scale, and wherein

FIG. 1 is a block diagram of an illustrative configurable personalized display system, according to an example embodiment of the invention.

FIG. 2 is an illustrative example vehicle with personalized displays, according to an example embodiment of the invention.

FIG. 3 is a flow diagram of an example method, according to an example embodiment of the invention.

### DETAILED DESCRIPTION

In the following description, numerous specific details are set forth. However, it is understood that embodiments of the invention may be practiced without these specific details. In other instances, well-known methods, structures, and techniques have not been shown in detail in order not to obscure an understanding of this description. References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

As used herein, the term vehicle can refer generally to an automobile, car, truck, passenger vehicle, bus, or the like.

As used herein, unless otherwise specified, the use of the terms display can refer generally to any device or system that can be selectively altered in appearance. Examples include devices that can change optical density, color, or selectively display text, images, or video. Example devices include liquid crystal displays, light-emitting diode displays, image projectors, E-ink displays, electrochromic elements, polarization elements, etc.

According to example embodiments of the invention, one or more displays may be attached to or integrated with a vehicle for displaying information or altering aspects about the vehicle based, for example, on who is in the vehicle or where the vehicle is located. According to example embodiments, the display information may convey personalized information about one or more occupants of the vehicle, for example, to be viewed by people outside of the vehicle. In certain example embodiments, the display information may also be viewable by those inside the vehicle, for example, on a monitor or display inside the vehicle. In accordance with certain example embodiments, the display information may be generated based on a detection of the driver and/or passenger(s) of the vehicle. For example, various sensors, including cameras, weight sensors, etc., may be placed in the cabin and configured to determine the identity of one or more occupants of the vehicle.

According to example embodiments, the identity (or identities) may be determined based on pattern recognition and may use previously gathered physical characteristics, profile information, etc. According to other example embodiments, an occupant without a previously generated profile may be detected. In this situation, the system may include a process for learning a new identity, gathering and associating data with the new identity, and building a new preference profile for the new occupant. According to example embodiments, the system may include a process for refining a preference profile associated with a known occupant based on additional sensed information and/or from additional input provided by the known occupant.

According to an example embodiment, a unique identity of a driver may be determined, and personalized display items and/or personalized display preferences may be retrieved or selected based on a profile associated with the determined identity In another example embodiment, the in-vehicle sensors may detect identities of multiple occupants in the vehicle and may select items or display preferences for display based on . the combination of occupants, for example, from a group profile. According to an example embodiment, the group profile used for identifying and/or selecting display information may be based, at least in part, on certain commonalities shared by the occupants. According to example embodiments, the group profile may be spliced together from items from one or more of the occupants. For example, a family may have four members, each with diverse tastes and preference profiles. in one mode, the system may attempt to find commonality that exists in the preference profiles for each member of the family. For example, the entire family may be fans of a common sports team, and the team logo or image of the team mascot, or the score of a recent game may be selected and displayed. According to an example embodiment, a group profile may exist that does not exist in any one of the member's profiles but is created specifically for the group or occasion. For example a group profile such as “The Anderson Family Reunion” may be created or exist for a particular occasion. According to art example embodiment, commercial third party profiles may be available for download as an “app” and vendors may offer these to occupants for purchase in certain situations. These profiles may also include advertisements for which the driver could receive compensation.

According 10 other example embodiments, identities of one or more occupants may be determined, and information related to a particular identified occupant, based on their preference profiles, may be routed to a display nearest the identified occupant. According to another example embodiment, the selected information may be routed to one or more displays for expressing the views, personality, affiliation, etc., associated with the determined profile, whether it be of the driver, a passenger. or a group of two or more persons in the vehicle.

According to an example embodiment, the preference profile selected or utilized for setting preferences of the reconfigurable display(s), or for selecting the content for display, may be based on a default profile. According to an example embodiment, the default profile may he utilized, for example, when there is not sufficient information or confidence related to the identification of one or more occupants of the vehicle. According to another example embodiment. the default profile may be utilized or selected by a driver or other occupant, for example, to override automatic configuration of the display system. In yet another example embodiment, a default profile may be associated with a particular identity.

In accordance with example embodiments, the information for display may be further selected based on a physical location oldie vehicle. For example, a display profile may include a selection based at least in part on coordinates of a global positioning system (GPS). According to example embodiments, the information for display may be selected based at least in part on proximity to one or more objects. For example, the selection of information may be based on proximity to a location, or to another vehicle. According to an example embodiment, the system may be configured to sense certain radio frequency beacons, and information may be selected for display based, at least in part, on the sensed beacon.

In accordance with certain example embodiments, a remote web server may be utilized for configuring preference profiles. In one embodiment, a person may configure his/her profile via an Internet connection to a website. In accordance with example embodiments, the website may be in communication with a server that may be configured to communicate wirelessly with the vehicle for providing display content and other profile information when the particular person is in the vehicle. According to other example embodiments, a portable memory device, such as a cell phone, a key fob, RFID chip, bar code, etc. may be utilized for transferring profile preference information to the vehicle display system. These items may also be utilized for determining the identity of the person in the vehicle.

According to example embodiments, user profile information and/or display information may he stored either in the vehicle or on a device, such as a smart phone or tablet, and be transferred to the vehicle. In other example embodiments, the information could be downloaded to the vehicle via a wireless connection. The wireless connection may include a wireless “cloud” network, cellular communication channels, etc. According to example embodiments, a computation system may reside in the vehicle, on a device brought into the vehicle by the user (e.g. smart phone or tablet), or in the cloud. In example embodiments, user devices may communicate with the vehicle using, wireless connections such as Bluetooth. According to example embodiments, the profile hosting processors (which may exist in the cloud, on a user device, or in the vehicle) may communicate to processors on the vehicle to control the displays.

According to certain example embodiments, a dedicated web application, such as those used on smart phones and similar devices, may be utilized lot identifying, selecting and/or downloading display content for the vehicle personalized display system. According to an example embodiment, a fee may be charged for access to the content. For example, certain protected or copyrighted material, such as a team logo, may be desired by an occupant of the vehicle for display purposes. According to an example embodiment, the web application may be used to streamline the process of selecting content, integrating the content with the user preference profile, and generating revenue for the owner of the content.

According to example embodiments, preference profiles may be associated with one or more occupants of the vehicle, and profiles may be time and space dependent. For example, the location of the vehicle, or the proximity of the vehicle to a location, may be used for modifying the display information, or characteristics associated with the vehicle. For example, the profiles may be configured to turn off the displays (or switch display information) when approaching a place of employment, or when approaching a child's school. According to an example embodiment, the profiles could include advertisements for a business establishment. For example, a revenue or rewards program may be established between a business and a vehicle occupant or owner so that when the vehicle comes within a certain radius of the business, an advertisement for that business may appear on one or more of the displays. A number of scenarios may exist where the user preference profiles may be set up for generating revenue via a relationship between advertisers and a user. According to an example embodiment, a preference profile may include an agreement to display advertisements on the user's vehicle. For example, information related to an undersold concert or sporting event may be displayed per an—agreed—upon arrangement. Other examples of messages that may be displayed via the user preference profiles include display messages such as “Good Morning!” between 6 am and 10 am. Another example message may be used for expressing the outcome of certain events, for example “Atlanta Braves win World Series!”

In accordance with example embodiments, the vehicle display can include any device capable of displaying one or more of text, images, or video. For example, light-emitting diode (LED) displays or liquid crystal displays (LCD) may be attached, positioned, integrated or embedded on the vehicle for displaying information, in another example embodiment, one or more projectors may he attached, positioned, or embedded in the vehicle for projecting images onto certain parts of the vehicle, including the hood, trunk, doors, etc. In other example embodiments, E-ink technology may be utilized for displaying information on windows or other components associated with the vehicle.

According to example embodiments, the vehicle display can include devices that can selectively modify light transmission levels, tint, color, opacity, etc. According to example embodiments, window shading, tinting, opacity, color, or transparency may be controlled based on the identity profile of one or more occupants of the vehicle, and/or on the location of the vehicle. For example, electrochromic elements, liquid crystal elements, or other configurable or controllable light blocking or modifying devices may be embedded or attached to the vehicle windows to provide various levels of controllable tinting. In certain example embodiments, GPS coordinates may be utilized for hiding the identity (which may include gender, ethnicity, etc.) of the vehicle occupant(s) while the vehicle is in certain areas.

Embodiments of the invention will now be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

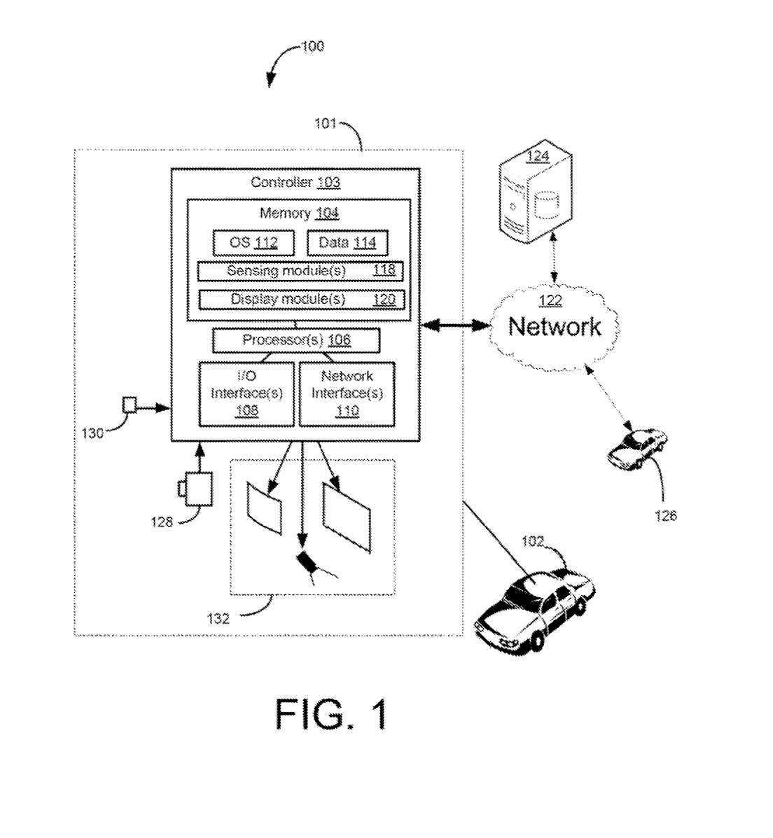

FIG. 1 illustrates a configurable personalized display system 100, according to an example embodiment. The system 100 may include certain components 101 that may be attached to, integrated within, or otherwise associated with a vehicle 102. According to an example embodiment, components 101 may include a controller 103 and one or more displays 132. In accordance with example embodiments, the one or more displays may include devices mentioned previously, such as screens, video displays, projectors, controllably tinting windows, etc.

According to example embodiments, the system 100 may also include an in-vehicle camera 128 for capturing images within the vehicle 102 for determining the identity of one or more occupants. According to example embodiments, other sensors 130 may be included in the components 101 within the vehicle 102. For example, the sensors 130 may include a weight measurement device for identifying occupants of the vehicle 102 based, at least in part, on weight. In an example embodiment, the sensors 130 may include a microphone for receiving audible information, such as a voice response from one or more occupants of the vehicle 102. Other examples of the sensors 130 may include other biometric readers, RFID readers, bar code readers, memory stick readers, Bluetooth readers, smart keys, etc., for gathering information from the one or more occupants of the vehicle.

In accordance with an example embodiment, the controller 103 may include a memory 104, one or more processors 106, and one or more input/output interfaces 108 for communication with the camera 128, sensors 130, and/or displays 132. In an example embodiment, the memory 104 may include an operating system 112 and data 114. According to an example embodiment, the memory 104 may include one or more modules comprising computer-readable code that may configure the one or more processors 106. For example, the memory 104 may include one or more sensing modules 118 that may be utilized by the one or more processors 106 to interpret information obtained by the sensors 130, camera 128, or other data gathering device within the vehicle 102, for example to determine the identity of one or more occupants of the vehicle. The memory 104 may also include one or more display modules 120 that may be utilized for selecting and routing display information to the one or more displays 132 based on a preference profile of the one or more occupants of the vehicle 102.

According to an example embodiment, the controller 103 may also include a network interface 110. The network interface may be utilized for communication with a user device, such as a cell phone, key fob, RFID, etc. According to an example embodiment, the network interface 110 may be utilized for communicating wirelessly to a remote server 124 via a network 122. According to certain example embodiments, the controller 103 within the vehicle 102 may be in communication with another vehicle 126 via the network interface 110 and a wireless network 122.

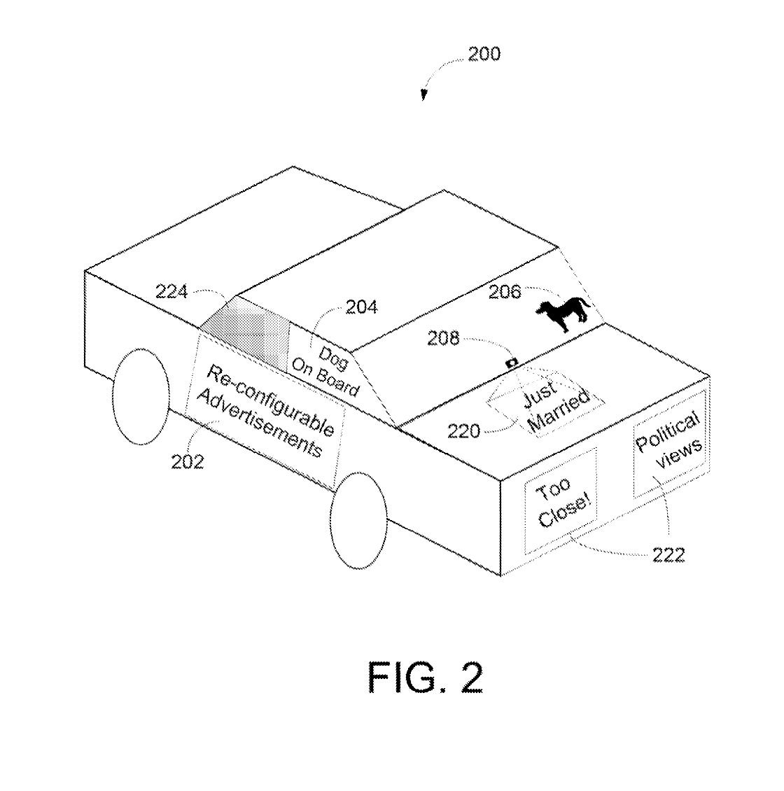

FIG. 2 depicts an example vehicle 200 with personalized displays, according to an example embodiment of the invention. According to an example embodiment, the displays may be utilized for presenting information, or for controlling certain visual aspects associated with the vehicle 200. For example, the displays may present electronically reconfigurable text, graphics, images, and/or video. According to an example embodiment, a side display panel 202 may be utilized for presenting or displaying reconfigurable advertisements. The side display panel 202 may be utilized for presenting other information associated with the personalized displays, according to an example embodiment of the invention. The example vehicle 200 depicts several other example displays, according to example embodiments, for presenting electronically reconfigurable text, graphics, images, and/or video. For example, according to an example embodiment, the vehicle may include one Or more of side window displays 204 and/or rear window displays 206. According to example embodiments, the vehicle 200 may include one or more projectors 208 for projecting display information onto surfaces 220 associated with the vehicle 200, According to example embodiments, rear-mounted displays 222 may be utilized, for example, to display electronically reconfigurable information to people behind the vehicle 200. These displays may be considered to be electronic, bumper suckers, since the information may be dynamically changed or turned on or off in response to the automatic or manual controls discussed previously. According to example embodiments, the vehicle 200 may also include configurable window tinting 224 that may be controlled manually, or based on user preference profiles or locations. According to an example embodiment, the window tinting 224 may be configured electronically in response to other sensed information, including but not limited to light levels, such as sunshine intensity, or lack of external light.

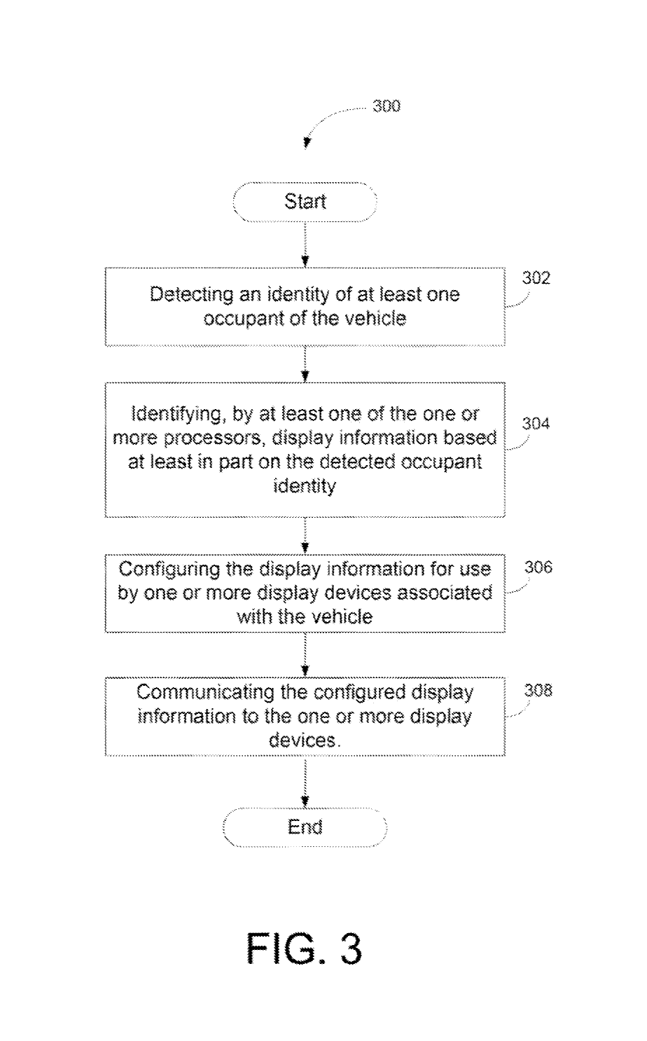

An example method 300 for executing computer-executable instructions by one or more processors for displaying personalized information on a vehicle will now be described with reference to the flow diagram of FIG. 3. The method 300 starts in block 302 and, according to an example embodiment of the invention, includes detecting an identity of at least one occupant of the vehicle. In block 304, the method 300 includes identifying, by at least one of the one or more processors, display information based at least in part on the detected occupant identity. In block 306, the method 300 includes configuring the display information for use by one or more display devices associated with the vehicle. In block 308, the method 300 includes communicating the configured display information to the one or more display devices. The method 300 ends alter block 308.

According to example embodiments, certain technical effects cast be provided, such as creating certain systems, methods, and apparatus that enable occupants of a vehicle to display personalize information on the vehicle. Example embodiments of the invention can provide the further technical effects of providing systems, methods, and apparatus for detecting the identity of one or more occupants of a vehicle, and displaying personalized information based on a user preference profile associated with the detected identity. Example embodiments of the invention can provide the further technical effects of providing systems, methods, and apparatus for dynamically con figuring display information based on one or more of a detected occupant identity, a detected group of occupants, the location of the vehicle, a time, and/or a proximity of the vehicle to other objects, vehicles, or locations.

In example embodiments of the invention, personalized configurable display system 100 may include any number of hardware and/or software applications that are executed to facilitate any of the operations. In example embodiments, one or more input/output interfaces may facilitate communication between configurable personalized display system 100 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the configurable personalized display system 100. The one or more input/output interfaces may be utilized to receive or collect data and/or user instructions from a wide variety of input devices. Received data may be processed by one or more computer processors as desired in various embodiments of the invention and/or stored in one or more memory devices.

One or more network interfaces may facilitate connection of the configurable personalized display system 100 inputs and outputs to one or more suitable networks and/or connections, for example, the connections that facilitate communication with any number of sensors associated with the system. The one or more network interfaces may further facilitate connection to one or more suitable networks for example, a local area network, a wide area network, the Internet, a cellular network, a radio frequency network, a Bluetooth™ (owned by Telefonaktiebolaget LM Ericsson) enabled network, a Wi-Fi™ (owned by Wi-Fi Alliance) enabled network, a satellite-based network, any wired network, any wireless network, etc., for communication with external devices and/or systems.

As desired, embodiments of the invention may include the configurable personalized display system 100 with more or less of the components illustrated in FIG. 1

Certain embodiments of the invention are described above with reference to block and flow diagrams of systems and methods and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention,

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more Functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks or the block diagrams and flow diagrams support combinations of means For performing the specified functions, combinations of elements or steps for performing the specified functions and program instruction means for performing, the specified functions. It will also be understood that each block of the block diagrams and Flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

The written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method comprising executing computer-executable instructions by one or more processors for displaying personalized information on a vehicle, the method further comprising:
detecting an identity of at least one occupant of the vehicle;
identifying, by at least one of the one or more processors, display information based at least in part on the detected occupant identity;
configuring the display information for use by one or ore display devices associated with the vehicle: and
communicating the configured display information to the one or more display devices.

2. The method of claim 1, wherein detecting the identity of at least one occupant of the vehicle comprises one or more of:
selecting an identity from a plurality of authorized identities:
selecting a probable identity from a plurality of past identities; or
comparing information associated with the at least one occupant that is acquired by one or more sensors associated with the vehicle with stored information to determine occupant identity.

3. The method of claim 1, further comprising, receiving a profile for the detected occupant identity.

4. The method of claim 3, wherein configuring the display information is based at least in part on the profile.

5. The method of claim 1, wherein configuring the display information comprises further identifying the display information based on one or more of digital personal information, recommendation information, third-party information, time information, position or GPS information, web application information, or a profile.

6. The method of claim 1, wherein configuring the display information comprises receiving input or approval for personalized display information from the at least one occupant.

7. The method of claim 1, wherein communicating the configured personalized display information to the one or more display devices comprises transmitting graphical or control information from the uric or more processors to one or mote of a projector, an ink display, display, an electrochromic glass panel, a motor, or a display driver.

8. A vehicle comprising:
one or more display devices:
one or more sensors for detecting an identity of an occupant of the vehicle;
at least one memory for storing, data and computer-executable instructions;
at least one processor configured to access the at least one memory and further configured to execute the computer-executable instructions to:
detect an identity of at least one occupant in the vehicle;
identify display information based at least in part on the identity of the at least one detected occupant;
configure the display information for use by one or more display devices associated with the vehicle; and
communicate the configured display information to the one or more display devices.

9. The vehicle of claim 8, wherein the at least one processor is further configured to detect the identity o r at least one occupant of the vehicle by one or more of:
selecting an identity from a plurality of authorized identities:
selecting a probable identity from a plurality of past identities; or
comparing information associated with the at least one occupant that is acquired by one or more sensors associated with the vehicle with stored information to determine occupant identity.

10. The vehicle of claim 8, wherein the at least one processor is further configured to receive a profile for the detected occupant identity.

11. The vehicle of claim 10, wherein the at least one processor configures the display information based at least in part on the received profile.

12. The vehicle of claim 8, wherein the at least one processor configures the display information by selecting the display information based on one or more of digital personal information, recommendation information, third-party information, time information, position or OPS information, web application information, or a profile.

13. The vehicle of claim 8, wherein the at least one processor configures the display information by receiving input or approval for display information from the at least one occupant.

14. The vehicle of claim 8, wherein the display information is communicated to the one or more display devices by transmitting graphical or control information from the one or more processors to one or more of a projector, an e-ink display, an electrochromic glass panel, a motor, or a display driver.

15. The vehicle of claim 8, wherein the one or more sensors for detecting an identity of an occupant of the vehicle comprise one or more of a camera, a weight detector, a shape detector an RFID reader, a microphone, or a biometric feature detector.

16. An apparatus comprising:
at least one memory for storing data and computer-executable instructions;
at least one processor configured to access the at least one memory and further configured to execute the computer-executable instructions to:
detect an identity of at least one occupant of a vehicle;
select display information based at least in part on the identity of the at least one detected occupant;
configure the display information for use by one or more display devices associated with the vehicle; and
communicate the configured display information to the one or more display devices.

17. The apparatus of claim 16, wherein the at least one processor is further configured to detect the identity of at least one occupant of the vehicle by one or more of:
selecting an identity from a plurality of authorized identities;
selecting probable identity from a plurality of past identities; or
comparing information associated with the at least one occupant that is acquired by one or more sensors associated with the vehicle with stored information to determine occupant identity.

18. The apparatus or claim 16, wherein the at least one processor is further configured to receive a profile for the detected occupant identity.

19. The apparatus of claim 18, wherein configuring the display information is based at least in part on the received profile.

20. The apparatus of claim 16, wherein the at least one processor configures the display data by selecting the display information based on one or more of digital personal information, recommendation information, third-party information, time information, position or GPS information, web application information, or a profile.

21. The apparatus of claim 16, wherein the display information is communicated to the one or more display devices by transmitting graphical or control information from the one or more processors to one or more of a projector, an e-ink display, an electrochromic glass panel, a motor, or a display driver.

22. A computer program product, comprising a computer-usable medium having a computer-readable program code embodied therein, said computer readable program code adapted to be executed to implement a method for displaying information on a vehicle, the method further comprising:
detecting an identity of at least one occupant of the vehicle;
identifying, by at least one of the one or more processors, display information based at least in part on the detected occupant identity of the at least one occupant;
configuring the display information for use by one or more display devices associated with the vehicle, and
communicating the configured display information to the one or more display devices.

23. The computer program product of claim 22, wherein detecting the identity of at least one occupant of the vehicle comprises one or more of:
selecting an identity from a plurality of authorized identities;
selecting a probable identity from a plurality of past identities; or comparing information associated with the at least one occupant that is acquired by one or more sensors associated with the vehicle with stored information to determine occupant identity.

24. The computer program product acclaim 22, further comprising receiving a profile for the detected occupant identity.

25. The computer program product of claim 24, wherein configuring the display information is based at least in part on the profile.

26. The computer program product of claim 22, wherein configuring the display information comprises further identifying the display information based on one or more of: digital personal information, recommendation information, third party information; time information, position or GPS information, web application information, or a profile.

27. The computer program product of claim 22, wherein configuring the display information comprises receiving input or approval for display information from the at least one occupant.

28. The computer program product of claim 22, wherein communicating the configured display information to the one or more display devices comprises transmitting graphical or control information from the one or more processors to one or more of a projector, an e-ink display, an electrochromic glass panel, a motor, or a display driver.
